(19) United States
(12) Patent Application Publication
(10) Pub. No.: US 2015/0166020 A1
(43) Pub. Date: Jun. 18, 2015

(54) SPRAY WASHER NOZZLE FOR VEHICLE

(71) Applicants: Hyundai Motor Company, Seoul (KR); Kia Motors Corporation, Seoul (KR)

(72) Inventors: Nak Kyoung Kong, Seongnam-Si (KR); Bock Cheol Lee, Suwon-si (KR); Young Sub Oh, Suwon-si (KR); Dae Hwan Kim, Daejeon (KR); Hyun Sub Kim, Seoul (KR); Byoung Gyu Park, Suwon-si (KR); Jin Hee Lee, Seoul (KR); Joon Ho Sung, Yangsan-si (KR)

(73) Assignees: Hyundai Motor Company, Seoul (KR); Kia Motors Corporation, Seoul (KR)

(21) Appl. No.: 14/528,116

(22) Filed: Oct. 30, 2014

(30) Foreign Application Priority Data
Dec. 16, 2013 (KR) 10-2013-0156179

(51) Int. Cl. B60S 1/52

(52) U.S. Cl. CPC B60S 1/52

(57) ABSTRACT

A spray washer nozzle for a vehicle may include an inlet for inflow of a washer fluid, an outlet for spraying the washer fluid, a channel formed between the inlet and the outlet, and a neck formed ahead of the inlet in the channel. A front and a rear steady stream-generating spaces may be formed at each of both sides around inner edges of the channel, and the front and rear steady stream-generating spaces at each of both sides may be separated by a corresponding separation wall of separation walls protruding toward a center line of the channel in a width direction of the channel.

### CROSS-REFERENCE TO RELATED APPLICATION

The present application claims priority of Korean Patent Application Number 10-2013-0156179 filed on Dec. 16, 2013, the entire contents of which application are incorporated herein for all purposes by this reference.

### BACKGROUND OF INVENTION

1. Field of Invention

The present invention relates to a spray washer nozzle for a vehicle, and more particularly, to a spray type of a washer nozzle that removes foreign substances on a windshield of a vehicle by spraying a washer fluid to the windshield.

2. Description of Related Art

In general, a windshield is mounted on the front of a vehicle to block wind or secure the front view of a driver while the vehicle is in motion.

Since the surface of the windshield is frequently stained with various foreign substances, it is necessary that the foreign substances attached on the glass be removed to secure a sufficient front view for safe driving.

All vehicles are equipped with a wiper system and a washer nozzle for spraying a washer fluid to remove foreign substances attached on the windshield.

Therefore, when a driver activates a washer switch around the driver's seat for a clear view, a washer motor connected to the washer switch is operated, washer fluid stored in a washer fluid tank is sprayed through the washer nozzle by operating the washer motor, and foreign substances that interfere with driving are removed by the washer fluid sprayed and the operation of the wipers, such that the driver can drive safely with the view secured.

Because washer nozzles for vehicles usually require washing a large area with a small amount of a wash fluid within a short time, there have been attempts to increase the wash area, using spray types of washer nozzles.

Korean Patent Application Publication No. 10-2009-0047963A discloses a spray type of a washer nozzle.

For example, the spray types of washer nozzles of the related art are operated in such a way that a center stream returns through a feedback channel and induces a flow of a center stream passing through an inlet, with very narrow spray angles of about 40˜45° (see, Related art 1 in FIG. 4) and ones that are difficult to use for medium and large vehicles because they are operated in a way that two flows coming through narrow spaces generate three steady streams by hitting each other and a flow to the outlet is generated by flows of the steady streams, with in sufficient spray angles of about 60˜70° (see, Related art 2 in FIG. 4).

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a spray type of a washer nozzle with an increased spray angle which can replace the existing spray washers having narrow spray areas by implementing a new type of spray washer nozzle that sprays washer fluid at a large spray angle through the outlet, using flows of a center stream and steady streams.

A spray washer nozzle of the present invention may include: an inlet for inflow of a washer fluid, an outlet for spraying the washer fluid, a channel formed between the inlet and the outlet, and a neck formed ahead of the inlet in the channel, wherein a front and a rear steady stream-generating spaces are formed at each of both sides around inner edges of the channel, and the front and rear steady stream-generating spaces at each of both sides are separated by a corresponding separation wall of separation walls protruding toward a center line of the channel in a width direction of the channel.

Accordingly, in the spray washer nozzle, a flow of a center stream is induced by movement in the steady stream-generating spaces and the spray angel of washer fluid can be rapidly increased at the outlet.

The neck may be formed between two structures, each with a curved surface, at both sides in the width direction of the channel and ahead of the inlet. Widths of the inlet, the outlet, and the neck satisfy a relationship of inlet<neck≦outlet. In the longitudinal direction of the channel, a length of an inlet channel between the inlet and the separation walls may be larger than a length of an outlet channel between the separation walls and the outlet.

The separation walls dividing the steady stream-generating spaces forward and backward at each of both sides may be formed substantially in a V-shape and an angle of the V-shape may be 60˜70°. An angle between one side of the V-shape of one or each of the separation walls and the center line of the channel in the width direction of the channel may be 45˜55°.

According to the spray washer nozzle provided by the present invention, since left and right flows of a center stream is induced by movement of steady streams such as four steady streams in the channel and the spray angle of washer fluid is rapidly increased at the outlet of the nozzle, the spray angle of washer fluid can be increased large, about 70˜82° and a large wash area is secured. Therefore, the spray nozzle can be effectively used for medium and large vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and are thus not limitative of the present invention, and wherein:

FIGS. 1A-1C are perspective views showing an exemplary spray washer nozzle according to the present invention;

FIGS. 2A-2B are plan views showing an internal channel of an insert chip in exemplary spray washer nozzle according to the present invention;

FIGS. 3A-3E are plan views showing the operation principle of an exemplary spray washer nozzle according to the present invention; and

FIG. 4 is a plan view showing the shapes and flow analysis of an exemplary spray washer nozzle according to the present invention and spray washer nozzles of the related art.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

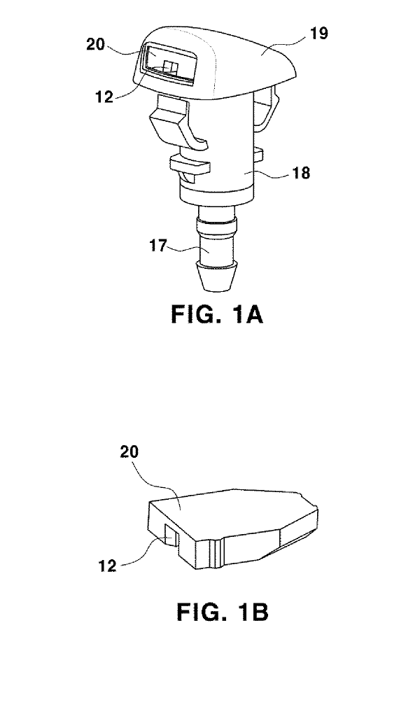

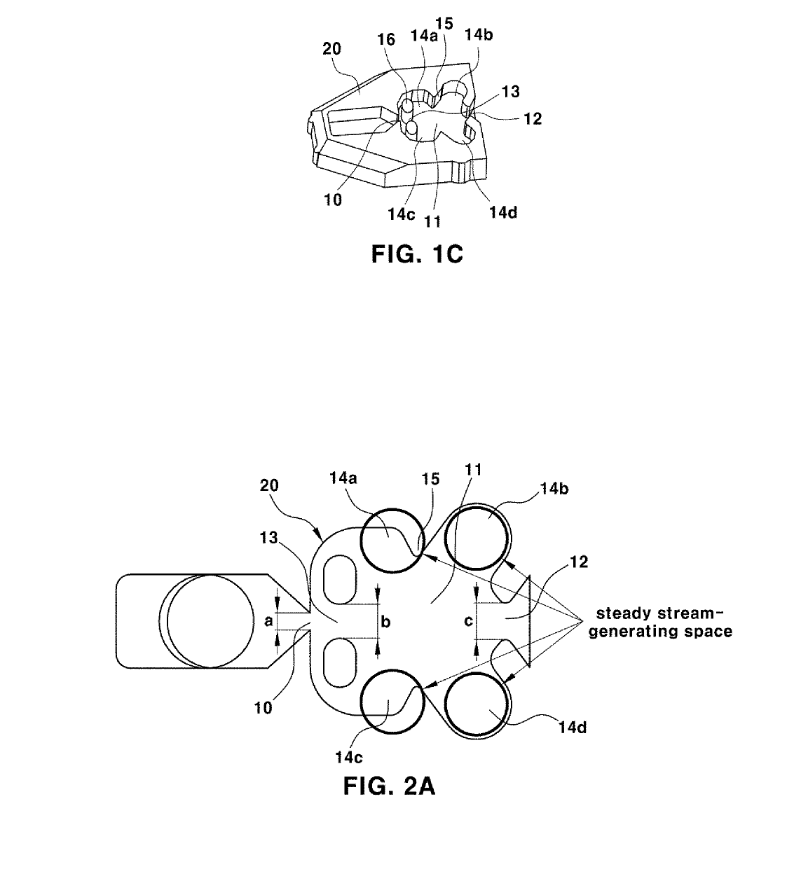

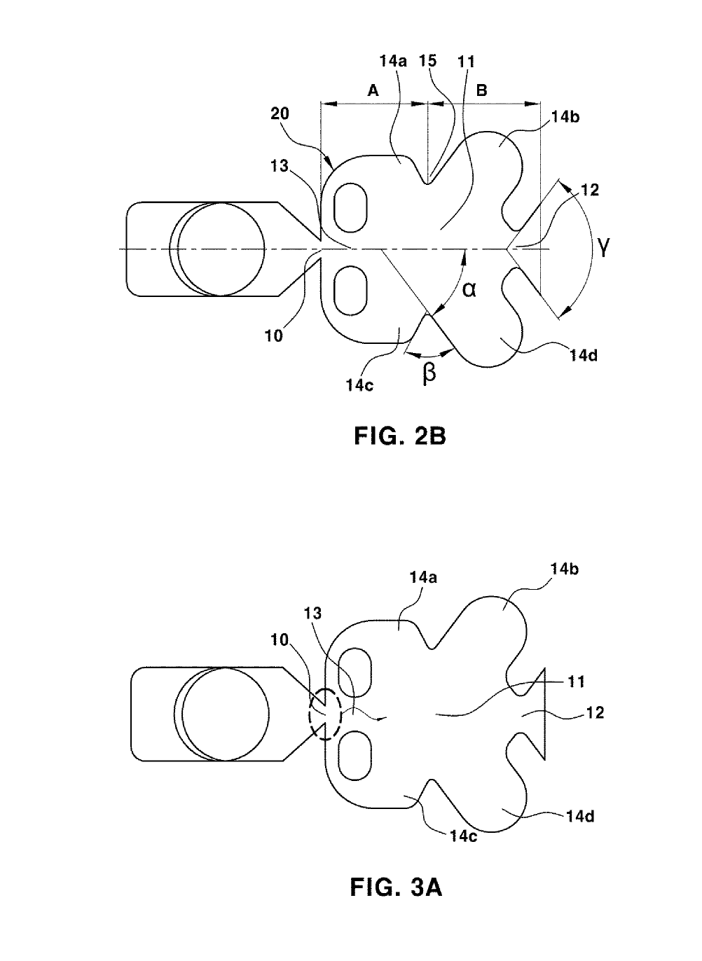

FIGS. 1A-1C are perspective views showing a spray washer nozzle according to various embodiments of the present invention and FIGS. 2A-2B are plan views plan view showing an internal channel of an insert chip in the spray washer nozzle according to various embodiments of the present invention.

As shown in FIGS. 1A-2B, the spray washer nozzle, a device that is mounted on the hood of a vehicle and sprays washer fluid to a windshield, includes a joint 17 connected with a hose for supplying washer fluid, a housing 18 fixed to a hood panel, a head 19 for spraying a washer fluid, and an insert chip 20 with a channel therein.

The insert chip 20 is a part mounted on the head 19 and actually spraying a washer fluid, an inlet 10 through which washer fluid flows inside and an outlet 12 through which washer fluid is sprayed are formed in the insert chip 20, and the space between the inlet 10 and the outlet 12 defines a channel 11.

A neck 13 is defined inside the channel 11, between two or more structures 16 with a circular or elliptical curved surface at both sides in the width direction of the channel, ahead of the inlet 10, and the washer fluid flowing inside through the inlet 10 generates a center stream while passing through the neck 13.

Separation walls such as two separation walls 15 protruding toward the center of the channel width from the edge of the channel and facing each other are formed inside the channel 11, in which the section ahead of the separation walls 15 may be an inlet channel and the section behind may be an outlet channel.

In particular, in some embodiments, two steady stream-generating spaces 14a and 14b or 14c and 14d are provided at the area around each of both sides inside the channel 11, as parts that can induce a flow of a center stream, in which the two front and rear steady stream-generating spaces 14a, 14b and 14c, 14d can be divided by the separation walls 15.

That is, two steady stream-generating spaces 14a and 14b or 14c and 14d are formed at each of both sides from the center line extending through the width center of the channel 11, and the steady stream-generating spaces 14a, 14b and 14c, 14d formed as described above can be divided forward and backward by the separation wall 15 therebetween, such that steady stream-generating spaces making a rectangular symmetric structure can be formed at four positions.

Further, the sizes of the widths of the inlet 10, the outlet 12, and the neck 13 may satisfy the relationship of inlet 10<neck 13≦outlet 12 (a<b≦c).

That is, the width of the inlet 10 may be smaller than the width of the narrow cannel 13 and the width of the neck 13 may be the same as or smaller than the width of the outlet 12.

Further, in the longitudinal direction of the channel, the length A of the inlet channel corresponding to the section between the inlet 10 and the separation walls 15 may be larger than or the same as the length B of the outlet channel corresponding to the section between the separation walls 15 and the outlet 12.

The separation wall 15 dividing the two steady stream-generating spaces 14a, 14b and 14c, and 14d forward and backward at each of both sides may be formed substantially in a V-shape and the angle β of the V-shape may be 65° or more, and in some embodiments, preferably 65˜70°.

The angle α between one side of the V-shape of the separation wall 15 and the line extending through the width center of the channel may be 50° or more, and in some embodiments, preferably 50˜60°.

The expansion angle γ of the spray portion extending outward from the outlet 12 of the channel 11 may be 100° or more, and in some embodiments, preferably 100˜110°.

In the spray washer nozzle with this structure, a flow of a center stream traveling out of the neck is induced by movement of steady streams due to the steady stream-generating spaces in the nozzle, and accordingly, the spray angle of washer fluid can be rapidly increased at the outlet of the nozzle by the flow of the center stream.

That is, left and right flows are induced while the center stream passes through the neck at the portion that comes into the channel from the inlet through which the washer fluid in the nozzle flows inside and steady streams are generated by the steady stream-generating spaces therein, which are circular flow spaces, due to the left and right flows, such that the center stream goes out to the outlet while moved to the left and right by the flows of the steady streams, and thus the spray angle of the washer fluid can be increased.

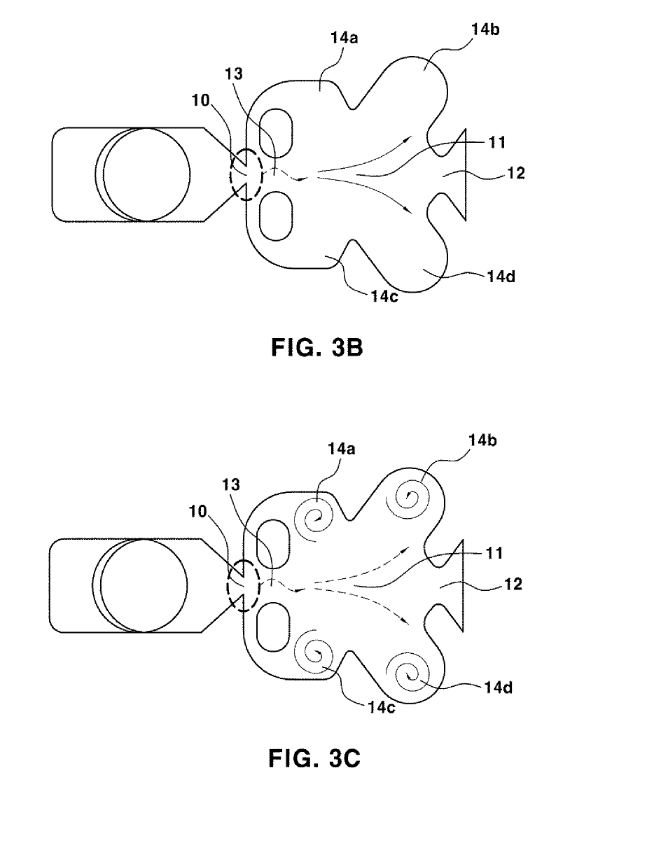

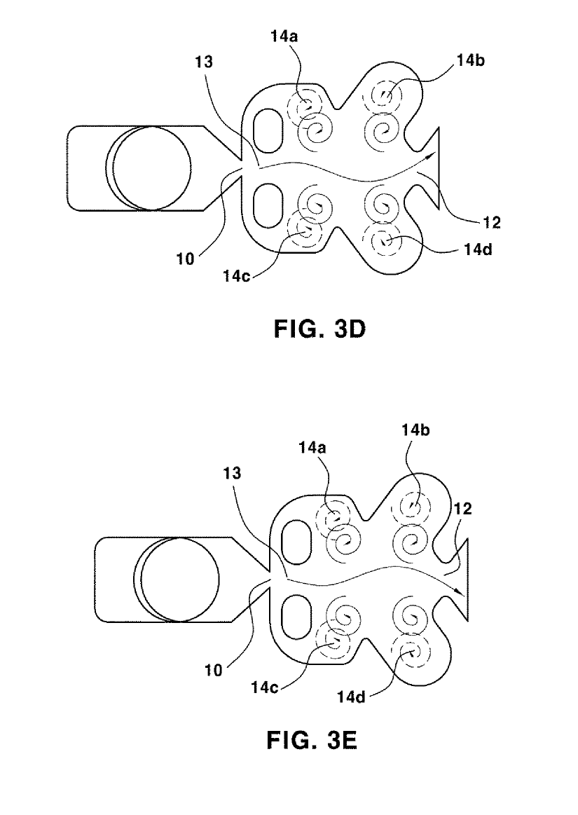

FIGS. 3A-3E are plan views showing the operation principle of the spray washer nozzle according to various embodiments of the present invention.

As shown in FIGS. 3A-3E, the center stream flowing into the channel 11 through the inlet 10 through which washer fluid in the nozzle flows inside induces left and right flows while passing through the neck 13 formed by the circular or elliptical structures 16.

Steady streams are generated in the steady stream-generating spaces 14a-14d in the channel by the flow of the center stream.

As a result, large flows of the steady streams are generated by the flow of the center stream, a large flow of the center stream is generated at the outlet 12, and the spray angle of the washer fluid can be increased.

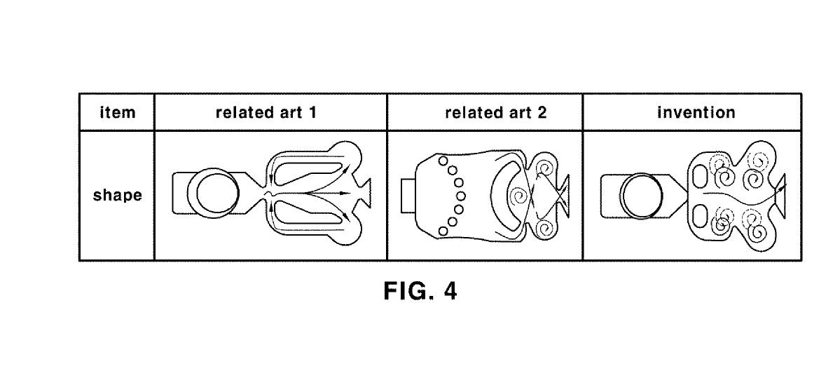

Accordingly, as can be seen in FIG. 4, in the nozzle of the present invention, since the center stream is moved through the neck after passing through the inlet and generates steady streams, and the angle of the flow out of the outlet is increased by flow of the steady streams.

As described above, in the present invention, since the flow relationship of a center stream and steady streams inside the nozzle is improved and left and right flows of the center stream can be induced at the outlet of the nozzle, a large washer fluid spray angle can be secured, for example, a washer fluid spray angle of about 70˜82° can be secured, and accordingly, the nozzle can be appropriately used for medium and large vehicles that require large wash areas.

For convenience in explanation and accurate definition in the appended claims, the terms “left” or “right”, “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A spray washer nozzle for a vehicle, comprising:
an inlet for inflow of a washer fluid;
an outlet for spraying the washer fluid;
a channel formed between the inlet and the outlet; and
a neck formed ahead of the inlet in the channel,
wherein a front and a rear steady stream-generating spaces are formed at each of both sides around inner edges of the channel, and
the front and rear steady stream-generating spaces at each of both sides are separated by a corresponding separation wall of separation walls protruding toward a center line of the channel in a width direction of the channel.

2. The spray washer nozzle of claim 1, wherein the neck is formed between two structures, each with a curved surface, at both sides in the width direction of the channel and ahead of the inlet.

3. The spray washer nozzle of claim 1, wherein widths of the inlet, the outlet, and the neck satisfy a relationship of inlet<neck≦outlet.

4. The spray washer nozzle of claim 1, wherein in a longitudinal direction of the channel, a length of an inlet channel between the inlet and the separation walls is larger than a length of an outlet channel between the separation walls and the outlet.

5. The spray washer nozzle of claim 1, wherein the separation walls dividing the steady stream-generating spaces forward and backward at each of both sides are formed substantially in a V-shape and an angle of the V-shape is 60˜70°.

6. The spray washer nozzle of claim 1, wherein an angle between one side of the V-shape of one or each of the separation walls and the center line of the channel in the width direction of the channel is 45˜55°.
